(19) United States
(12) Patent Application Publication
(10) Pub. No.: US 2016/0036525 A1
(43) Pub. Date: Feb. 4, 2016

(54) SYSTEM FOR OPTICAL DATA TRANSMISSION, OPTICAL DATA RECEIVE UNIT, OPTICAL DATA TRANSMIT UNIT AND METHOD FOR OPTICAL DATA COMMUNICATION

(71) Applicant: Siemens Aktiengesellschaft, Muenchen (DE)

(72) Inventor: Georg Pirkl, Dormitz (DE)

(73) Assignee: Siemens Aktiengesellschaft, Muenchen (DE)

(21) Appl. No.: 14/812,165

(22) Filed: Jul. 29, 2015

(30) Foreign Application Priority Data
Jul. 29, 2014 (DE) 102014214859.6

(51) Int. Cl. H04B 10/079; G06F 13/42; G08C 23/04

(52) U.S. Cl. CPC H04B 10/07955; G08C 23/04; G06F 13/4282

(57) ABSTRACT

A system for optical data transmission has at least a first optical data transmission component that has a first optical data receive unit. They system further has a second optical data transmission component that has a first optical data transmit unit, and the system further has at least one optical waveguide, through which the first optical data receive unit and the first optical data transmit unit connected and through which data are transmitted from the first optical data transmit unit to the first optical data receive unit. The first optical data receive unit has a first light power measuring unit for measuring the light power transmitted through the at least one optical waveguide, and the first light power measuring unit is designed to generate an electrical status signal depending on the measured light power, and to make that signal available to a first control unit.

### BACKGROUND OF THE INVENTION

1. Field of the Invention

The present invention concerns a system for optical data transmission, an optical data receive unit, an optical data transmit unit and a method for optical data communication.

2. Description of the Prior Art

In data transmission, information, i.e. data, is generally transferred from a transmitter or a source to a receiver or a sink. Depending on the type of application, certain requirements are imposed on the data transmission technology to be used. If there are particular requirements relating to a high maximum bandwidth and/or a high electromagnetic compatibility, abbreviated to EMC, optical data transmission offers advantages over other types of data transmission. In this type of transmission, glass fibers are usually used as optical waveguides, which deliver a high data transfer rate, are not influenced by electrical devices in their environment, e.g. by electromagnetic influences and offer a high level of robustness, since the data transmission is not influenced by other devices in the vicinity. In the field of medical technology in particular, these criteria are of great importance, which is why optical data transmission systems, for example for data transfer between digital imaging devices such as computed tomography (CT) systems, x-ray devices, ultrasound devices, or magnetic resonance tomography (MRT) systems, are used by preference. The disadvantages of optical data transmission systems include the higher costs caused by a more complex implementation and a high mechanical sensitivity of the glass fiber lines. Efforts are therefore made to keep the number of lines low. One measure is to carry out the data transmission serially instead of in parallel, thus reducing the number of data lines. A further method is not to use additional signal lines that are provided for special functions, with the consequence that these functions are no longer available.

The problems will be illustrated below using a PCI Express transmission system (abbreviated to PCI-E for Peripheral Component Interconnect-Express) as an example and using an application from the medical field, namely the optical connection of an MRT device to an MRT control computer. After the connection of an optical PCI-Express component to the MRT control computer or its optical interface card, which is in a switched-on state, i.e. a so-called “hot plug,” according to the current prior art the MRT control computer must be restarted, i.e. booted, so that it can recognize the additional component connected via optical waveguides. The reason for this is that, with an optical component, the actual PCI-Express “present” and “wake” intended for this purpose are not interrogated or not serviced. Furthermore, no reset signal can be sent to a component connected via optical waveguides if communication via the optical waveguides is blocked because of an error of the connected component. Once again this is due to the fact that the PCI-Express additional signal “PERST” intended for this purpose can likewise not be serviced for optical data transmission components. In this case the components connected via the optical waveguide components must be powered off, so that the PCI-Express communication is ready again and subsequently the MRT control computer is rebooted.

An obvious solution to the problem is for additional optical transmit and optical receive units to be provided for the aforementioned three signals, and to route additional optical waveguides between the MRT control computer or its interface car. This approach, however, is complex and not cost-effective.

### SUMMARY OF THE INVENTION

An object of the present invention is to provide a system for optical data transmission that requires no additional optical waveguides to make available an additional function and is thus less complex and more cost-effective than the solution known from the prior art. It is also an object of the invention to provide a corresponding data receive unit, a corresponding data transmit unit, and a corresponding method for optical data communication.

The basis of the invention is a system for optical data transmission having at least one first optical data transmission component, wherein the first optical data transmission component has a first optical data receive unit. The system further has a second optical data transmission component, wherein the second optical data transmission unit has a first optical data transmit unit. The system further has at least one optical waveguide through which data are transmitted from the first optical data transmit unit to the first optical data receive unit. The first optical data receive unit has a first optical power measuring unit that measures the optical power transmitted through the at least one optical waveguide. The first optical power measurement unit is designed to generate a first electrical status signal as a function of the measured optical power and to make that signal available to a control unit.

The inventive system is accordingly designed for optical data transmission. For this purpose the system has at least one first and at least one second optical data transmission component. The first optical data transmission component, which can be connected to a higher-ranking electronic component, e.g. an electrical circuit, such as a microprocessor of a computer, has a first optical data receive unit. The second optical data transmission component, which can be connected to a high-ranking electronic components, e.g. an electrical circuit, such as a microprocessor of a medical device, has a first optical data transmit unit. The system further has at least one optical waveguide, by which the first optical data receive unit can be connected to the first optical data transmit unit, so that an optical data transmission can take place. Data receive units, data transmit units, optical waveguides, their layout and the basic way in which they individually function are known. This also includes systems that have further optical data receive units, data transmit units and optical waveguides in order to make possible an optical data transmission known per se. In accordance with the invention, the first optical data receive unit has a first light power measuring unit for measuring the light power transmitted by the at least one optical waveguide. The first light power measuring unit is designed to generate a first electrical status signal that is dependent on the measured light power, and to make this signal available to a first control unit. The first light power measuring unit can be designed to measure the light power transmitted by the at least one optical waveguide with a photodiode, for example, and depending on the value of the measured light power, to generate a first electrical status signal that is made available to a first control unit. The first control unit can be an electronic circuit, for example. As well as the primary information, namely the data to be transmitted, which are generally transmitted through the optical waveguide in the form of a sequence of changes in light, in addition information relating to the light power is measured and is translated into information, here an electrical status signal. This additional information is available to the first control unit and can be interrogated, for example, by a higher-ranking circuit.

In an embodiment, the first electrical status signal has a first value when the measured transmitted light power exceeds a predetermined light power value and the first electrical status signal has a second value when the measured transmitted light power does not exceed the predeterminable light power value.

The predetermined light power value is a threshold value and the first light power measuring unit includes a comparator. When the measured transmitted light power is greater than this threshold value, the first electrical status signal is set to the first value, e.g. the value “logical 1”, otherwise the first electrical status signal is set second value, e.g. the value “logical 0”. Binary values are easier to further process, by a higher-ranking circuit for example.

In a further embodiment, the first optical data transmission component includes a second optical data transmit unit and the second optical data transmission component includes a second optical data receive unit. The second optical data transmit unit and the second optical data receive unit are connected by the at least one optical waveguide, and data are transmitted from the second optical data transmit unit to the second optical data receive unit through the at least one optical waveguide. The second optical data receive unit has a second light power measuring unit that measures the light power transmitted through the at least one optical waveguide, and the second light power measuring unit generates a second electrical status signal, dependent on the measured light power, and makes it available to a second control unit.

In this embodiment, the first optical data transmission component can include a first optical data receive unit and a second optical data transmit unit, the second optical data transmission component can include a first optical data transmit unit and a second optical data receive unit. The data transmit units and the data receive units can be connected by at least one optical waveguide. A data transmission can take place from the first optical data transmission component to the second optical data transmission component or vice versa, i.e. a bidirectional data transmission. In accordance with the invention the second optical data receive unit has a second light power measuring unit with which the transmitted light power through the at least one optical waveguide is measured. The second light power measuring unit generates a second electrical status signal independently of the measured light power and makes this available to the second control unit.

In a further embodiment, the first control unit and/or the second control unit is designed, depending on the first electrical status signal and/or depending on the second electrical status signal, to generate further electrical control signals, for which the signal forms can be predetermined.

For example, the first electrical status signal can be monitored over a predetermined period of time and a third electrical status signal will be allocated the value “logical 0” if the first electrical status signal has never assumed the value “logical 1” during this period of time, otherwise it is allocated the value “logical 1”. A fourth electrical status signal, on occurrence of a value “logical 0” of the second electrical status signal for a predeterminable period of time, is allocated the value “logical 1” and once again the value “logical 0”. Thus a pulse is produced with a defined length, which can be easily read out by a higher-ranking circuit.

Especially advantageously the first electrical status signal, made available to the first control unit, is a status signal that signals the presence of the second optical data transmission component, and/or the second electrical status signal made available to the second control unit is a status signal for resetting the second optical data transmission component.

So-called hot-plugging can be achieved through this feature, meaning that, as soon as the second optical data transmission component is coupled via an optical waveguide to the first optical data transmission component, the status signal changes dependent on the measured light power, which for example signals to a higher-ranking system that the second optical data transmission component can be used in the system, especially that there can be communication with this component. In other words the second optical data transmission component announces itself as present. Conversely the second optical data transmission component can be reset by a change of the second electrical status signal into a defined state, for example an initial state.

The first optical data transmission component and/or the second optical data transmission component can be part of a PCI-Express system.

A PCI-Express system is an industry standard fur connection of peripheral devices with a chipset of a central processor and is widely used, especially in medical technology. The use of an inventive optical data transmission with the PCI-Express-Standard offers the advantage of the availability of standardized components.

In a further embodiment, the first control unit, depending on the first electrical status signal, generates a Present signal and/or the first control unit, depending on the first electrical status signal, generates a Wake signal, and/or for the second control unit, depending on the second electrical status signal, generates a reset signal or a PERST signal.

As described in the introduction, the “Present”, “Wake” and “PERST” signals, provided for specific functions in the PCI-Express standard, are not considered or “noticed” in an optical data transmission. Through the inventive forms of embodiment these functions are now available again without additional optical waveguides having to be laid. This advantage can overcome the disadvantage of an additional implementation of the light power measuring unit or of the light power measuring units in many applications.

Preferably the system is able to be used in a medical system.

It is precisely in a medical system, such as a computed tomography system, an x-ray device, an ultrasound device or a magnetic resonance tomography device, in which large amounts of data must be transmitted securely and without disturbing surrounding devices, that the aforementioned advantages of an optical data transmission are frequently needed, so that one of the inventive devices can be advantageously employed.

It is possible for the first light power measuring unit and/or the second light power measuring unit to include a light power measuring unit known from Small-Form-Factor Optical Transceivers in accordance with IEEE 802.3.

A further basis of the invention is an optical data receive unit, wherein the optical data receive unit is able to be employed in one of the previously described systems for optical data transmission.

The optical data receive unit is able to be connected in a form of embodiment by means of an optical waveguide to an optical data transmit unit, so that data is able to be transmitted from the optical data transmit unit to the optical data receive unit. The optical data transmit unit includes a light power measuring unit for measuring the light power transmitted by the optical waveguide. The light power measuring unit is designed, depending on the measured light power, to generate an electrical status signal and to make said signal available to a control unit.

A further basis of the invention is an optical data transmit unit, wherein the optical data transmit unit is able to be employed in one of previously described systems for optical data transmission.

A further basis of the invention is a method for optical data communication, wherein the method employs one of the previously described systems for optical data transmission.

For example an inventive method includes the method step “measuring of the light power transmitted through an optical waveguide by a light power measuring unit”, the method step “generating a first electrical status signal as a function of the measured light power” and the method step “making the first electrical status signal available to a first control unit”.

### BRIEF DESCRIPTION OF THE DRAWINGS

FIG. 1 is a block diagram of a system for optical data transmission according to the prior art.

FIG. 2 is a block diagram of an exemplary embodiment of the inventive system for optical data transmission.

### DESCRIPTION OF THE PREFERRED EMBODIMENTS

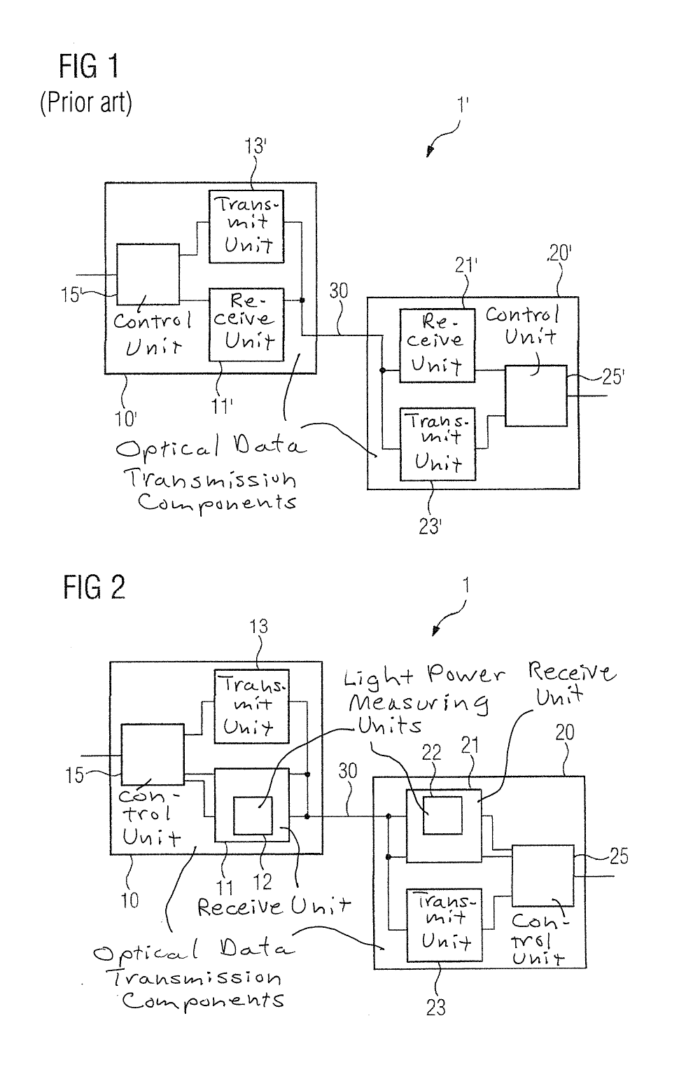

FIG. 1 is a block diagram of a system 1′ for optical data transmission according to the prior art. The system 1′ comprises a first optical data transmission component 10′ and a second optical data transmission component 20′. The first optical data transmission component 10′ has a first data receive unit 11′ and a second optical data transmit unit 13′. The second optical data transmission component 20′ has a first optical data transmit unit 23′ and a second optical data receive unit 21′. The data transmission components 10′ and 20′, i.e. the data transmit units and the data receive units are connected to each other by means of an optical waveguide 30, so the data can be transmitted by operation of a method known per se of optical data transmission from one of the optical data transmit units, 23′ or 13′, to one of the optical data receive units, 11′ or 21′. The data received by the first data receive unit 11′ is made available to a first control unit 15′, the data received by the second data receive unit 11′ is made available to a second control unit 25′. The control units 15′ and 25′ can likewise give data to the data transmit units 13′ and 23′ in order to transmit the data to one of the data receive units 11′ or 21′.

FIG. 2 is a block diagram of an exemplary embodiment of an inventive system 1 for optical data transmission. This system 1 has a first optical data transmission component 10 and a second optical data transmission component 20. The first optical data transmission component 10 has a first data receive unit 11 and a second optical data transmit unit 13. The second optical data transmission component 20 has a first optical data transmit unit 23 and a second optical data receive unit 21. The data transmission components 10 and 20, i.e. the data transmit units and the data receive units, are connected to one another via an optical waveguide 30, so that data can be transmitted by operation of the method of optical data transmission known per se from one of the optical data transmit units, 23 or 13, to one of the optical data receive units, 11 or 21. The data received by the first data receive unit 11 is made available to a first control unit 15, the data received by the second data receive unit 11 is made available to a second control unit 25. The control units 15 and 25 can likewise give data to the data transmit units 13 and 23, in order to transmit the data to one of the data receive units 11 or 21. Furthermore the control units 15 and 25 can be in communication with higher-ranking circuit, such as microprocessors or the like for example, and can communicate with those units.

In accordance with the invention the first optical data receive unit 11 has a first light power measuring unit 12 for measuring the light power transmitted through the optical waveguide 30. The first light power measuring unit 12 is designed to generate a first electrical signal depending on the measured light power, and to make that signal available to the first control unit 15. The first light power measuring unit 12 thus is designed to measure the light power transmitted through the at least one optical waveguide 30, for example with a photodiode and, depending on the value of the first optical power, to generate a first status signal which is made available to the first control unit 15. The first control unit 15 can involve an electronic circuit for example. As well as the primary information, namely the data to be transmitted, which is generally transmitted through the optical waveguide 30 in the form of a sequence of light changes, information relating to the light power is additionally measured and is translated into information, here an electrical status signal. This additional information is available to the first control unit 15 and can for example be interrogated by a higher-ranking circuit. The first control unit 15 can also be designed, depending on the first electrical control signal, to generate further electrical control signals of which the signal forms can be predetermined. For example pulse signals can be generated in this way when the measured light power has exceeded a threshold value which caused a corresponding first electrical status signal.

Furthermore the second optical data receive unit 21 has a second light power measuring unit 22 for measuring the light power transmitted through the at least one optical waveguide 30. The second light power measuring unit 22 is designed to generate a second electrical status signal depending on the measured light power, and to make that signal available for the second control unit 25. The light power measuring units 12 and/or 22 can be a light power measuring unit, as is frequently already integrated by default in a Small Form Factor Optical Transceiver according to IEEE 802.3.

Further embodiments and advantages of the invention are described in summary.

In commercially-available PCI-Express interface cards special signals such as the “Present” signal, the “Wake” signal and/or a reset signal, are usually not made available by separate optical connecting lines. The “Present” and “Wake” signal are created in an inventive form of embodiment by the incoming light power been measured in a type of measuring device. If the transmitting device is now not connected or is powered down, the light power falls below a predeterminable threshold which lies above the noise and above ambient scattered light. Falling below the threshold deactivates the “Present” signal. If the second threshold, which lies above the noise and the ambient scattered light indicates that once again sufficient light power is being received, the “Present” signal is activated again. In the PCI-Express implementation the “Wake” signal needs an impulse of a specific minimum length which is created when the second threshold is exceeded. If a “Reset” or “PERST” signal is to be created, the transmitting unit switches the light source off. The receiving unit once again has a light power measuring unit that activates the corresponding signal if a threshold is not reached. If a further threshold is exceeded again, then the corresponding signals are deactivated again. The corresponding light power measuring units have e.g. the often used Small-Form-Factor Optical Transceiver according to IEEE 802.3 already integrated by default.

A few significant advantages of the invention or forms of embodiment of the invention are as follows:

1. Use of the available optical waveguide which transmits a serial data stream in an optical PCI-Express architecture, for transmitting the reset signal “PERST”.

2. Use of the received light power in order to indicate that the transmitting part is connected and powered up. Use of the signal in order to create the PCI-Express signals “Present” and “Wake”.

3. Through the use of the available optical waveguide at least two further optical waveguides can be saved.

The described principle is not restricted to the optical PCI-Express architecture. It can be employed with all serial connections which communicate via optical waveguides.

Although modifications and changes may be suggested by those skilled in the art, it is the intention of the inventor to embody within the patent warranted hereon all changes and modifications as reasonably and properly come within the scope of his contribution to the art.

I claim as my invention:

1. A system for optical data transmission, comprising:
a first optical data transmission component comprising an optical data receive unit;
a second optical data transmission component comprising an optical data transmit unit;
an optical waveguide that places said optical data receive unit in optical transmission communication with said optical data transmit unit and through which said optical data transmit unit optically transmits light signals to said optical data receive unit;
said optical data receive unit comprising a light power measuring unit configured to measure light power transmitted through said optical waveguide to said optical data receive unit, said light power measuring unit being configured to generate an electrical status signal dependent on measured light power measured by said light power measuring unit; and
said first optical data transmission component comprising a control unit to which said electrical status signal is provided by said light power measuring unit.

2. A system as claimed in claim 1 wherein said light power measuring unit is configured to give said electrical status signal a first value when said measured light power exceeds a predetermined light power value, and to give said electrical status signal a second value when said measured light power does not exceed said predetermined light power value.

3. A system as claimed in claim 1 wherein said control unit is configured to generate a further electrical control signal, dependent on said electrical status signal, having a signal form that is predetermined dependent on said electrical status signal.

4. A system as claimed in claim 1 wherein said light power measuring unit is configured to generate said electrical status signal as an indicator, for said control unit, that said second optical data transmission component is connected to said optical waveguide.

5. A system as claimed in claim 1 wherein said first and second optical data transmission components are configured to operate in a PCI-Express system format.

6. A system as claimed in claim 5 wherein said control unit is configured to generate, dependent on said electrical status signal, at least one of a Present signal in said PCI-Express system format, and a Wake signal in said PCI-Express system format.

7. A system as claimed in claim 1 wherein said light power measuring unit is a light power measuring unit known from Small-Form-Factor Optical Transceivers in accordance with IEEE 802.3.

8. A system as claimed in claim 1 wherein said optical data receive unit is a first optical data receive unit, said optical transmit unit is a first optical transmit unit, said light power measuring unit is a first light power measuring unit, said electrical status signal is a first electrical status signal, and said control unit is a first control unit, and wherein said second optical data transmission component comprises a second optical data receive unit and said first optical data transmission component comprises a second optical data receive unit in optical transmission communication via said optical waveguide with said second optical transmit unit, and that receives light signals from said second optical transmit unit via said optical waveguide, and wherein said second optical data transmission component comprises a second light power measuring unit configured to measure light power transmitted through said optical waveguide to said second optical data receive unit, said second light power measuring unit being configured to generate a second electrical status signal, dependent on measured light power measured by said second light power measuring unit, and wherein said second optical data transmission component comprises a second control unit provided with said second electrical status signal by said second light power measuring unit.

9. A system as claimed in claim 8 wherein said first control unit is configured to generate a first electrical control signal, dependent on said first electrical status signal, having a signal form that is predetermined dependent on said first electrical status signal, and wherein said second control unit is configured to generate a second electrical control signal having a signal form that is predetermined dependent on said second electrical status signal.

10. A system as claimed in claim 8 wherein said first light power measuring unit is configured to generate said first electrical status signal as an indicator, for said first control unit, that said second optical data transmission component is connected to said optical waveguide, and wherein said second light power measuring unit is configured to generate said second electrical status signal as a signal, for said second control unit, to reset said second optical data transmission component.

11. A system as claimed in claim 8 wherein said first and second optical data transmission components are configured to operate in a PCI-Express system format.

12. A system as claimed in claim 11 wherein said first control unit is configured to generate, dependent on said first electrical status signal, at least one of a Present signal in said PCI-Express system format, and a Wake signal in said PCI-Express system format and wherein said second control unit is configured to generate, dependent on said second electrical status signal, a Reset signal or a PERST signal in said PCI-Express system format.

13. A system as claimed in claim 8 wherein at least one of said first light power measuring unit and second light power measuring unit is a light power measuring unit known from Small-Form-Factor Optical Transceivers in accordance with IEEE 802.3.

14. An optical data receive unit configured for operation in a system for optical data transmission, said system comprising a first optical data transmission component comprising said optical data receive unit, a second optical data transmission component comprising an optical data transmit unit, an optical waveguide that places said optical data receive unit in optical transmission communication with said optical data transmit unit and through which said optical data transmit unit optically transmits light signals to said optical data receive unit, and said first optical data transmission component comprising a control unit, and said optical data receive unit comprising:
a light power measuring unit configured to measure light power transmit through said optical waveguide to said optical data receive unit, said light power measuring unit being configured to generate an electrical status signal dependent on measured light power measured by said light power measuring unit; and
said light power measuring unit being configured to provide said electrical status signal to said control unit.

15. An optical data transmit unit configured for operation in a system for optical data transmission, said system comprising a first optical data transmission component comprising an optical data receive unit, a second optical data transmission component comprising an optical data transmit unit, an optical waveguide that places said optical data receive unit in optical transmission communication with said optical data transmit unit, said optical data receive unit comprising a light power measuring unit configured to measure light power transmitted through said optical waveguide to said optical data receive unit, said light power measuring unit being configured to generate an electrical status signal dependent on measured light power measured by said light power measuring unit, and said first optical data transmission component comprising a control unit to which said electrical status signal is provided by said light power measuring unit and said optical data transmit unit being configured to optically transmit light signals to said optical data receive unit.

16. A method for optical data transmission, comprising:
placing a first optical data transmission component comprising an optical data receive unit, in optical communication, via an optical waveguide, with a second optical data transmission component comprising an optical data receive unit;
via said optical waveguide, transmitting light signals from said optical data transmit unit to said optical data receive unit;
with a light power measuring unit at said optical data receive unit measuring light power transmitted through said optical waveguide to said optical data receive unit, and in said light power measuring unit, generating an electrical status signal dependent on measured light power measured by said light power measuring unit; and
said first optical data transmission component comprising a control unit and providing said electrical status signal from said light power measuring unit to said control unit.
